(19) United States
(12) Patent Application Publication
(10) Pub. No.: US 2023/0327686 A1
(43) Pub. Date: Oct. 12, 2023

(54) ELECTRONIC DEVICE FOR PERFORMING COMMUNICATION USING MULTIPLE FREQUENCY BANDS AND OPERATION METHOD OF ELECTRONIC DEVICE

(71) Applicant: Samsung Electronics Co., Ltd., Gyeonggi-do (KR)

(72) Inventors: John MOON, Gyeonggi-do (KR); Hyoseok NA, Gyeonggi-do (KR)

(21) Appl. No.: 18/201,280

(22) Filed: May 24, 2023

Related U.S. Application Data
(63) Continuation of application No. PCT/KR2021/016522, filed on Nov. 12, 2021.

(30) Foreign Application Priority Data
Nov. 25, 2020 (KR) 10-2020-0159702

(51) Int. Cl. H04B 1/00; H04B 1/04

(52) U.S. Cl. CPC H04B 1/0067; H04B 1/0064; H04B 1/04; H04W 88/06

(57) ABSTRACT

In certain embodiments, a method of operating an electronic device, comprises: identifying strength of a signal within a first frequency band and strength of a signal within a second frequency band when operating in a mode of transmitting a signal within the first frequency band and a signal within the second frequency band; identifying first magnitudes of voltages based on mapping data in a memory, wherein the mapping data maps first magnitudes of the voltages according to strength of signal within the first frequency band and second magnitudes of the voltages according to strength of signal within the second frequency band, and the identified strength of the signal within the first frequency band; identifying the second magnitudes of the voltages based on the identified strength of the signal within the second frequency band and the mapping data; when there are identical magnitude of voltages among the first magnitudes of voltages applicable and the second magnitudes of voltages, controlling a power supply circuit to apply the identical magnitude of voltages to a first amplifier and/or a second amplifier.

### CLAIM OF PRIORITY

This application is a continuation of International Application No. PCT/KR2021/016522 filed on Nov. 12, 2021, which in turn claims priority to Korean Patent Application No. 10-2020-0159702 filed on Nov. 25, 2020 in the Korean Intellectual Property Office, the disclosures of which are herein incorporated by reference.

### BACKGROUND

### 1. Technical Field

Certain embodiments of the present disclosure relate to an electronic device that performs communication using a plurality of frequency bands, and a method of operating the electronic device.

### 2. Description of Related Art

A variety of electronic devices have been widely distributed, such as smartphones, tablet PCs, portable multimedia players (PMPs), personal digital assistants (PDAs), laptop personal computers (PCs), or wearable devices.

Electronic devices are capable of supporting communication. A communication method that utilizes a plurality of frequency bands may have greater frequency bandwidth than a communication method that utilizes a single frequency band. The communication method that utilizes a plurality of frequency bands with a relatively large frequency bandwidth may also have a higher transmission bit rate or reception bit rate compared to other communication methods.

To support the communication method using a plurality of frequency bands, the electronic device may include a plurality of communication circuits (e.g., front-end modules) configured to perform communication in each frequency band. The communication circuit may include an amplifier to amplify a signal to be transmitted. The amplifier is capable of amplifying a signal with power from a power supply circuit.

To transmit signals within a plurality of frequency bands, amplifiers included in the plurality of communication circuits may amplify signals received from a transceiver. A signal to be output in a first frequency band may have a different strength than a signal within a second frequency band. Accordingly, the magnitude of voltage applied to an amplifier that amplifies a signal within the first frequency band and the magnitude of voltage applied to an amplifier amplifies the signal within the second frequency band may be different. Since the voltages applied to the amplifiers may vary in magnitude, a plurality of power supply circuits may be included for the plurality of communication circuits.

Increasing the number of frequency bands supported by an electronic device increases, may also require an increase in the number of communication and power supply circuits. The increased number of power supply circuits consume more space and increase complexity.

An electronic device according to certain embodiments of the present disclosure may transmit signals of a plurality of frequency bands with a single power supply circuit providing power to the amplifiers.

### SUMMARY

In certain embodiments, an electronic device comprises: a communication processor; a memory storing mapping data mapping first magnitudes of voltages according to strength of a signal within a first frequency band, and second magnitudes of voltages according to strength of a signal within a second frequency band; and a first amplifier configured to amplify a signal within the first frequency band; a second amplifier configured to amplify a signal within the second frequency band; and a power supply circuit configured to apply a voltage to the first amplifier and/or the second amplifier, and wherein when operating in a mode of transmitting a signal within the first frequency band and a signal within the second frequency band, the communication processor is configured to: identify strength of a signal within the first frequency band and strength of a signal within the second frequency band; identify first magnitudes of voltages applicable to the first amplifier based on the strength of the signal within the first frequency band and the mapping data; identify second magnitudes of voltages applicable to the second amplifier based on the strength of the signal within the second frequency band and the mapping data; and when there are identical magnitudes of voltages among the first magnitudes of voltages and the second magnitudes of voltages, control the power supply circuit to apply the identical magnitudes of voltages to the first amplifier and/or the second amplifier.

In certain embodiments, an electronic device comprises: a communication processor; and a first amplifier configured to amplify a signal within a first frequency band; a second amplifier configured to amplify a signal within a second frequency band; and a power supply circuit configured to apply voltages to the first amplifier and the second amplifier, wherein when operating in a mode of outputting a signal within the first frequency band and a signal within the second frequency band, the communication processor is configured to: identify strength of a signal within the first frequency band and strength of a signal within the second frequency band; and control the power supply circuit to apply identical voltages to the first amplifier and the second amplifier based on the strength of the signal within the first frequency band and the strength of the signal within the second frequency band.

In certain embodiments, a method of operating an electronic device, comprises: identifying strength of a signal within a first frequency band and strength of a signal within a second frequency band when operating in a mode of transmitting a signal within the first frequency band and a signal within the second frequency band; identifying first magnitudes of voltages based on mapping data in a memory, wherein the mapping data maps first magnitudes of the voltages according to strength of signal within the first frequency band and second magnitudes of the voltages according to strength of signal within the second frequency band, and the identified strength of the signal within the first frequency band; identifying the second magnitudes of the voltages based on the identified strength of the signal within the second frequency band and the mapping data; when there are identical magnitude of voltages among the first magnitudes of voltages applicable and the second magnitudes of voltages, controlling a power supply circuit to apply the identical magnitude of voltages to a first amplifier and/or a second amplifier.

### BRIEF DESCRIPTION OF THE DRAWINGS

FIG. 1 is a block diagram illustrating an electronic device according to certain embodiments of the present disclosure.

FIG. 2 is a block diagram illustrating the electronic device for supporting legacy network communication and 5G network communication according to certain embodiments.

FIG. 3 is a block diagram illustrating the electronic device according to certain embodiments of the present disclosure.

FIG. 4 is a block diagram illustrating the electronic device according to certain embodiments of the present disclosure.

FIG. 5 is a view illustrating a first amplifier and a second amplifier in the electronic device according to certain embodiments of the present disclosure.

FIG. 6 is an operational flowchart illustrating a method of operating the electronic device according to certain embodiments of the present disclosure.

### DETAILED DESCRIPTION

According to certain embodiments, a single power supply circuit may be utilized to supply a voltage to operate a plurality of amplifiers. Therefore, even though the number of frequency bands that are used for communication increases, the space occupied by the power supply circuit does not increase. The foregoing conserves space.

According to certain embodiments, a voltage to be applied to the first amplifier and/or the second amplifier may be determined on the basis of the mapping data. The mapping data includes a plurality of voltage/bias voltage combinations to apply to the first amplifier and/or the second amplifier according to strength of the respective output signals. Therefore, the electronic device can simultaneously transmit signals within a plurality of frequency bands using a single power supply circuit. The single power supply circuit may apply different bias voltages to the first amplifier and/or the second amplifier, even though the same voltage is applied.

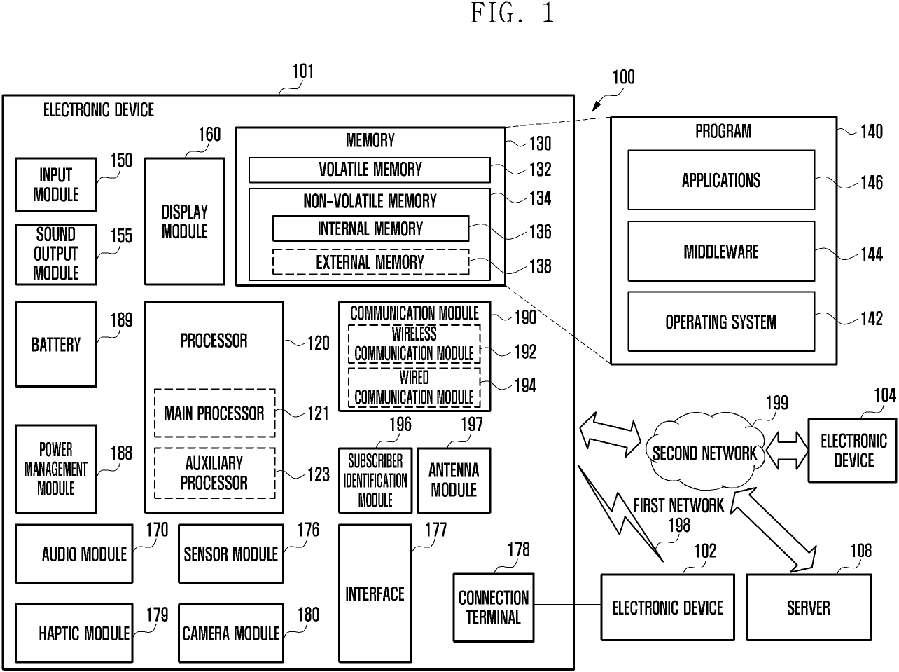

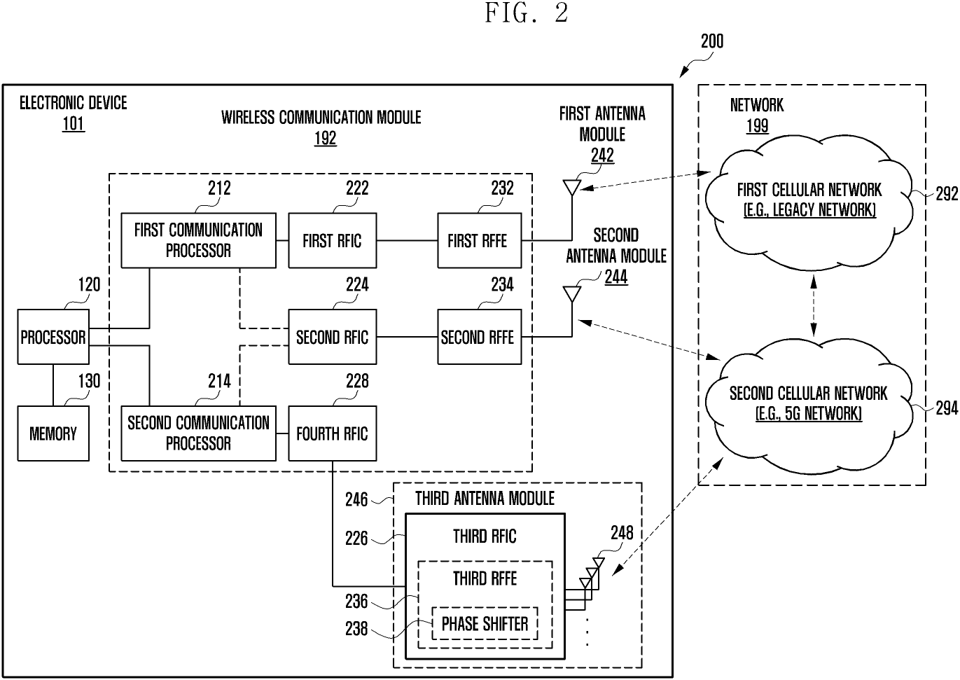

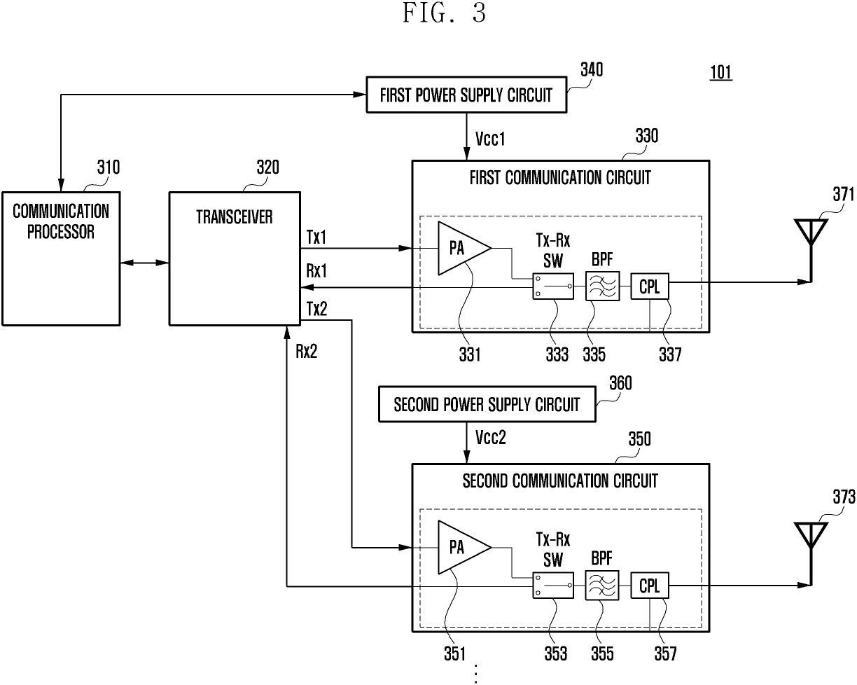

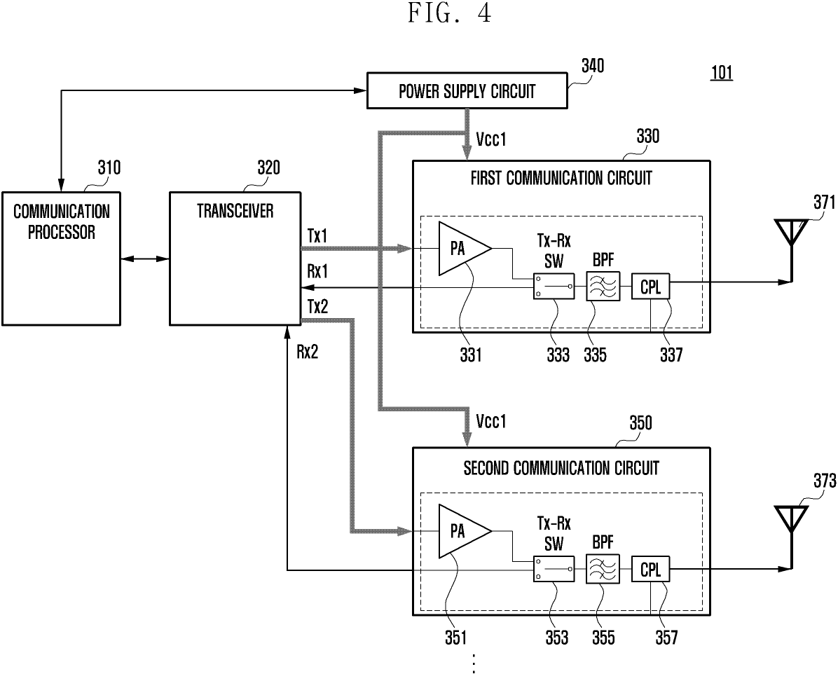

FIG. 1 describes an electronic device that supports communication on a plurality of frequency bands. FIG. 2 describes a wireless communication module 192 of an electronic device 101 that supports communication on a plurality of frequency bands. Signals received and transmitted for the plurality of frequency bands may be amplified by a corresponding plurality of amplifiers. The amplifiers use power to amplify the signals. In FIG. 3, a plurality of amplifiers receive power Vcc from a plurality of of power supply circuits. The plurality of power supply circuits consume space in the electronic device. Consuming space is especially a concern when the electronic device is portable electronic device, such as a smartphone. In a portable electronic device, a larger size reduces the portability. In contrast, in FIG. 4, a single power supply circuit provides power to each amplifier. Use of a single power supply circuit preserves space in the electronic device.

### Electronic Device

FIG. 1 describes an electronic device 101 that can communicate using a plurality of frequency bands.

FIG. 1 is a block diagram illustrating an electronic device 101 in a network environment 100 according to certain embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. The term “processor” shall refer to both the singular and plural contexts in this document. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to certain embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

It is noted that the electronic device 101 can communicate using multiple different frequency bands. As is shown in FIG. 2, there may be different antennas, radio frequency front ends (RFFE), and radio frequency integrated circuits for each different frequency band.

FIG. 2 is a block diagram 200 of an electronic device 101 for supporting legacy network communication and 5G network communication according to certain embodiments. Referring to FIG. 2, the electronic device 101 may include a first communication processor 212, a second communication processor 214, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, and an antenna 248. The electronic device 101 may further include the processor 120 and the memory 130. The network 199 may include a first network 292 and a second network 294. According to another embodiment, the electronic device 101 may further include at least one component among the components illustrated in FIG. 1, and the network 199 may further include at least one other network. According to an embodiment, the first communication processor 212, the second communication processor 214, the first RFIC 222, the second RFIC 224, the fourth RFIC 228, the first RFFE 232, and the second RFFE 234 may be included as at least a part of the wireless communication module 192. According to another embodiment, the fourth RFIC 228 may be omitted or may be included as a part of the third RFIC 226.

The first communication processor 212 may establish a communication channel of a band to be used for wireless communication with the first network 292, and may support legacy network communication via the established communication channel. According to certain embodiments, the first network may be a legacy network including 2G, 3G, 4G, or long term evolution (LTE) network. The second communication processor 214 may establish a communication channel corresponding to a designated band (e.g., approximately 6 GHz to 60 GHz) among bands to be used for wireless communication with the second network 294, and may support 5G network communication via the established channel. According to certain embodiments, the second network 294 may be a 5G network defined in 3GPP. Additionally, according to an embodiment, the first communication processor 212 or the second communication processor 214 may establish a communication channel corresponding to another designated band (e.g., lower than 6 GHz) among bands to be used for wireless communication with the second network 294, and may support 5G network communication via the established channel. According to an embodiment, the first communication processor 212 and the second communication processor 214 may be implemented in a single chip or a single package. According to certain embodiments, the first communication processor 212 or the second communication processor 214 may be implemented in a single chip or a single package, together with the processor 120, the sub-processor 123, or the communication module 190.

In the case of transmission, the first RFIC 222 may convert a baseband signal generated by the first communication processor 212 into a radio frequency (RF) signal in a range of approximately 700 MHz to 3 GHz used for the first network 292 (e.g., a legacy network). In the case of reception, an RF signal is obtained from the first network 292 (e.g., a legacy network) via an antenna (e.g., the first antenna module 242), and may be preprocessed via an RFFE (e.g., the first RFFE 232). The first RFIC 222 may convert the preprocessed RF signal to a baseband signal so that the base band signal is processed by the first communication processor 212.

In the case of transmission, the second RFIC 224 may convert a baseband signal generated by the first communication processor 212 or the second communication processor 214 into an RF signal (hereinafter, a 5G Sub6 RF signal) of a Sub6 band (e.g., lower than 6 GHz) used for the second network 294 (e.g., 5G network). In the case of reception, a 5G Sub6 RF signal is obtained from the second network 294 (e.g., a 5G network) via an antenna (e.g., the second antenna module 244), and may preprocessed by an RFFE (e.g., the second RFFE 234). The second RFIC 224 may convert the preprocessed 5G Sub6 RF signal into a baseband signal so that the baseband signal is processed by a corresponding communication processor from among the first communication processor 212 or the second communication processor 214.

The third RFIC 226 may convert a baseband signal generated by the second communication processor 214 into an RF signal (hereinafter, a 5G Above6 RF signal) of a 5G Above6 band (e.g., approximately 6 GHz to 60 GHz) to be used for the second network 294 (e.g., 5G network). In the case of reception, a 5G Above6 RF signal is obtained from the second network 294 (e.g., a 5G network) via an antenna (e.g., the antenna 248), and may be preprocessed by the third RFFE 236. The third RFIC 226 may convert the preprocessed 5G Above6 RF signal to a baseband signal so that the base band signal is processed by the second communication processor 214. According to an embodiment, the third RFFE 236 may be implemented as a part of the third RFIC 226.

According to an embodiment, the electronic device 101 may include the fourth RFIC 228, separately from or as a part of the third RFIC 226. In this instance, the fourth RFIC 228 may convert a baseband signal generated by the second communication processor 214 into an RF signal (hereinafter, an IF signal) in an intermediate frequency band (e.g., approximately 9 GHz to 11 GHz), and may transfer the IF signal to the third RFIC 226. The third RFIC 226 may convert the IF signal to a 5G Above6 RF signal. In the case of reception, a 5G Above6 RF signal is received from the second network 294 (e.g., a 5G network) via an antenna (e.g., the antenna 248), and may be converted into an IF signal by the third RFFE 226. The fourth RFIC 228 may convert the IF signal to a baseband signal so that the base band signal is processed by the second communication processor 214.

According to an embodiment, the first RFIC 222 and the second RFIC 224 may be implemented as a single chip or at least a part of the single package. According to an embodiment, the first RFFE 232 and the second RFFE 234 may be implemented as a single chip or at least a part of the single package. According to an embodiment, at least one antenna module of the first antenna module 242 or the second antenna module 244 may be omitted, or may be combined with another antenna module so as to process RF signals in a plurality of bands.

According to an embodiment, the third RFIC 226 and the antenna 248 may be disposed in the same substrate, and may form the third antenna module 246. For example, the wireless communication module 192 or the processor 120 may be disposed in a first substrate (e.g., main PCB). In this instance, the third RFIC 226 is disposed in a part (e.g., a lower part) of the second substrate (e.g., a sub PCB) separate from the first substrate and the antenna 248 is disposed on another part (e.g., an upper part), so that the third antenna module 246 is formed. By disposing the third RFIC 226 and the antenna 248 in the same substrate, the length of a transmission line therebetween may be reduced. For example, this may reduce a loss (e.g., attenuation) of a signal in a high-frequency band (e.g., approximate 6 GHz to 60 GHz) used for 5G network communication, the loss being caused by a transmission line. Accordingly, the electronic device 101 may improve the quality or speed of communication with the second network 294 (e.g., 5G network).

According to an embodiment, the antenna 248 may be implemented as an antenna array including a plurality of antenna elements which may be used for beamforming. In this instance, the third RFIC 226 may be, for example, a part of the third RFFE 236, and may include a plurality of phase shifters 238 corresponding to a plurality of antenna elements. In the case of transmission, each of the plurality of phase shifters 238 may shift the phase of a 5G Above6RF signal to be transmitted to the outside of the electronic device 101 (e.g., a base station of a 5G network) via a corresponding antenna element. In the case of reception, each of the plurality of phase shifters 238 may shift the phase of the 5G Above6 RF signal received from the outside via a corresponding antenna element into the same or substantially the same phase. This may enable transmission or reception via beamforming between the electronic device 101 and the outside.

The second network 294 (e.g., 5G network) may operate independently (e.g., Stand-Along (SA)) from the first network 292 (e.g., a legacy network), or may operate by being connected thereto (e.g., Non-Stand Alone (NSA)). For example, in the 5G network, only an access network (e.g., 5G radio access network (RAN) or next generation RAN (NG RAN)) may exist, and a core network (e.g., next generation core (NGC)) may not exist. In this instance, the electronic device 101 may access an access network of the 5G network, and may access an external network (e.g., the Internet) under the control of the core network (e.g., an evolved packed core (EPC)) of the legacy network. Protocol information (e.g., LTE protocol information) for communication with the legacy network or protocol information (e.g., New Radio (NR) protocol information) for communication with the 5G network may be stored in the memory 230, and may be accessed by another component (e.g., the processor 120, the first communication processor 212, or the second communication processor 214).

The plurality of antennas (242, 244, 248) may be associated with a corresponding plurality of amplifiers. The amplifiers may receive power from one or more power supply circuits. In FIG. 3, there are a corresponding plurality of power supply circuits, while in FIG. 4, a single power supply circuit provides power to the plurality of amplifiers.

FIG. 3 is a block diagram of an electronic device according to certain embodiments of the present disclosure.

With reference to FIG. 3, an electronic device may include a communication processor 310, a transceiver 320, a first communication circuit 330, a first power supply circuit 340, a second communication circuit 350, a second power supply circuit 360, a first antenna 371, and/or a second antenna 373.

The communication processor 310 may form a portion of the first communication processor 212 or the second communication processor 214 in FIG. 2. The transceiver 320 can form a portion of the first RFIC 222, second RFIC 224, third RFIC 226, or the fourth RFIC 228. The first antenna 371 and second antenna 373 may correspond to first antenna module 242, second antenna module 244, or third antenna module 248. The first communication circuit 330 and the second communication circuit 350 may form a portion of the first RFFE 232, or second RFFE 242.

The communication processor 310 may receive and/or transmit control data or user data through short-range wireless communications (e.g., Wi-Fi or Bluetooth) or cellular wireless communications (e.g., fourth generation mobile communications or fifth generation mobile communications). The communication processor 310 may establish a cellular communication connection with a base station through the control data, and transmit data received from the application processor (e.g., the processor 120 of FIG. 1) to the base station through the established cellular communication, or transmit data received from the base station to the application processor 120.

The transceiver 320 may perform various operations to process signals received from the communication processor 310. According to an embodiment, the transceiver 320 may perform a modulation operation on the signal received from the communication processor 310. For example, the transceiver 320 may perform a frequency modulation operation that converts a baseband signal into a radio frequency (RF) signal utilized for cellular communications. The transceiver 320 may also perform an operation to transform the signal phase according to a designated modulation scheme. The transceiver 320 may also perform a demodulation operation on a signal received from an external source through the communication circuit 330. For example, the transceiver 320 may perform a frequency demodulation operation that converts a radio frequency (RF) signal to a baseband signal. The transceiver 320 may also perform an operation to transform a signal phase according to a designated modulation scheme.

The transceiver 320 may provide signals with carrier frequencies corresponding to multiple different frequency bands for transmission. The transceiver may demodulate signals from multiple different frequency bands. In the case of signals for transmission, the signals for transmission are then amplified using an amplifier before transmission by an antenna. In the case of received signals, the received signals are received by an antenna, but have very small amplitude. Accordingly, an amplifier amplifies the received signals, prior to reception by the transceiver 320. Accordingly, there are a plurality of amplifiers corresponding to the plurality of frequency bands. The amplifiers can be incorporated into communication circuits.

The first communication circuit 330 may receive a signal radiated by an external source through the first antenna 371, or may radiate a signal transmitted by the transceiver 320 through the first antenna 371. The first communication circuit 330 may include various components (e.g., a first amplifier 331, a switch 333, a filter 335, and/or a coupler 337) that perform operations to amplify a signal received through the first antenna 371 and/or a signal transmitted by the transceiver 320, and process the amplified signals. A signal received or transmitted by the first communication circuit 330 may be, for example, a signal within a first frequency band.

The first amplifier 331 may amplify a signal within the first frequency band transmitted by the transceiver 320. The amplified signal may be transmitted to the first antenna 371 through the switch 333 to connect either a transmission path or a reception path with the filter 335, the filter 335 to pass a signal within a designated frequency band (e.g., the first frequency band), and/or the coupler 337 to monitor the amplified signal.

The second communication circuit 350 may receive an external signal through the second antenna 373, or may radiate a signal transmitted by the transceiver 320 through the second antenna 373. The second communication circuit 350 may include various components (e.g., a second amplifier 351, a switch 353, a filter 355, and/or a coupler 357) other than the second amplifier 351 that amplify a signal received through the second antenna 373 and/or a signal transmitted by the transceiver 320. The signal received or transmitted by the second communication circuit 350 may be a signal within a second frequency band. For example, the second frequency band may be a different band from the first frequency band.

The second amplifier 351 may amplify a signal within the second frequency band transmitted by the transceiver 320. The amplified signal may be transmitted to the second antenna 373 through the switch 353 to connect either a transmission path or a reception path with the filter 355, the filter 355 to pass a signal of a designated frequency band (e.g., the second frequency band), and/or the coupler 357 to monitor the amplified signal.

Amplifiers 331, 351 use power Vcc1 and Vcc2 to amplify signals. The power can be supplied by the power supply circuits 340, 360.

According to certain embodiments of the present disclosure, the first power supply circuit 340 may supply power that is required for the first amplifier 331 to operate. The first power supply circuit 340 may apply a voltage (e.g., VCC1) to the first amplifier 331 to supply power to the first amplifier 331.

The second power supply circuit 360 may supply power that is required for the second amplifier 351 to operate. The second power supply circuit 360 may apply a voltage (e.g., V_{CC2}) to the second amplifier 351 to supply power to the second amplifier 351.

A power supply circuit 340, 360 may include a DC to DC converter in certain embodiments. The DC to DC converter may be connected to the battery and either increase or decrease the output voltage according to a signal provided by the communication processor 310.

According to certain embodiments of the present disclosure, the electronic device 101 may include at least two or more communication circuits (e.g., the first communication circuit 330 and the second communication circuit 350) to support a communication method using at least two or more frequency bands, including the first frequency band and the second frequency band. For example, the electronic device 101 may support dual connectivity, which is a data communication method using different cellular communication methods (e.g., fourth generation cellular communication and fifth generation cellular communication), or carrier aggregation, which is a data communication method using a plurality of frequency bands. For example, the communication processor 310 may amplify a signal within the first frequency band through a first amplifier 331 and output the amplified signal through the first antenna 371, or amplify a signal within the second frequency band through the second amplifier 333 and output the amplified signal through the second antenna 373.

Due to a variety of factors, the gain needed to properly amplify signals may be different for each amplifier. The electronic device 101 may receive information from the base station (not illustrated) indicating a strength of a signal within the first frequency band to be transmitted and a strength of a signal within the second frequency band to be transmitted. The strength of the signal within the first frequency band to be transmitted and the strength of the signal within the second frequency band may be different. In this case, a gain of the first amplifier 331 and a gain of the second amplifier 335 may be different, and a voltage applied to the first amplifier 331 (Vcc1) and a voltage applied to the second amplifier 351 (Vcc2) may be different. The communication processor 310 may control the first power supply circuit 340 to apply a voltage corresponding to the strength of the signal within the first frequency band to be transmitted to the first amplifier 331, and may control the second power supply circuit 360 to apply a voltage corresponding to the strength of the signal within the second frequency band to be transmitted to the second amplifier 351.

As the number of frequency bands supported by the electronic device 101 increases, the number of communication circuits (e.g., the first communication circuit 330 and the second communication circuit 350) included in the electronic device 101 may increase. As the number of communication circuits 330 and 350 increases, the number of power supply circuits (e.g., the first power supply circuit 340 and the second power supply circuit 360) included may also increase, and the increase in the number of power supply circuits may result in an increase in a size of a space that the power supply circuits 340 and 360 occupy on the electronic device 101.

Hereinafter, embodiments of the electronic device 101 are described that utilize a single power supply circuit 340 or 360 to transmit signals within a plurality of frequency bands.

In FIG. 4, a single power supply circuit 340 provides power (Vcc1) to both the first power amplifier 331 of the first communication circuit 330 and the second power amplifier of the second communication circuit 350.

FIG. 4 is a block diagram of an electronic device according to certain embodiments of the present disclosure.

With reference to FIG. 4, an electronic device (e.g., the electronic device 101 of FIG. 1) according to certain embodiments of the present disclosure may include the communication processor 310, the transceiver 320, the first communication circuit 330, a first power supply circuit 340, the second communication circuit 350, the first antenna 371, and/or the second antenna 373. The same numeral references are used for constituent elements that are identical or similar to the constitutions illustrated in FIG. 3.

The communication processor 310 may form a portion of the first communication processor 212 or the second communication processor 214 in FIG. 2. The transceiver 320 can form a portion of the first RFIC 222, second RFIC 224, third RFIC 226, or the fourth RFIC 228. The first antenna 371 and second antenna 373 may correspond to first antenna module 242, second antenna module 244, or third antenna module 248. The first communication circuit 330 and the second communication circuit 350 may form a portion of the first RFFE 232, or second RFFE 242.The communication processor 310 may receive and/or transmit control data or user data through short-range wireless communications (e.g., Wi-Fi or Bluetooth) or cellular wireless communications (e.g., fourth generation mobile communications or fifth generation mobile communications). The communication processor 310 may establish a cellular communication connection with the base station through the control data, and transmit data received from an application processor (such as the processor 120 of FIG. 1) to the base station through the established cellular communication, or transmit data received from the base station to the application processor 120.

The transceiver 320 may perform various operations to process a signal received from the communication processor 310. In an embodiment, the transceiver 320 may perform a modulation operation on a signal received from the communication processor 310. For example, the transceiver 320 may perform a frequency modulation operation to convert a signal within the baseband to a signal within the first frequency band. The transceiver 320 may transmit a signal within the first frequency band to the first communication circuit 330. In another example, the transceiver 320 may convert a signal within the baseband to a signal within the second frequency band, and transmit the signal within the second frequency band to the second communication circuit 350.

The first communication circuit 330 may receive a signal radiating from an external source through the first antenna 371, or may radiate a signal transmitted by the transceiver 320 through the first antenna 371. The first communication circuit 330 may include various components (e.g., the first amplifier 331, the switch 333, the filter 335, and/or the coupler 337) in addition to the first amplifier 331 to amplify a signal received through the first antenna 371 and/or a signal transmitted by the transceiver 320. For example, a signal received or transmitted by the first communication circuit 330 may be a signal within the first frequency band.

The first amplifier 331 may amplify a signal within the first frequency band transmitted by the transceiver 320. The amplified signal may be transmitted to the first antenna 371 through the switch 333 to connect either a transmission path or a reception path with the filter 335, the filter 335 to pass a signal of a designated frequency band (e.g., the first frequency band), and/or the coupler 337 to monitor the amplified signal.

The second communication circuit 350 may receive a signal radiating from an external source through the second antenna 373, or may radiate a signal transmitted by the transceiver 320 through the second antenna 373. The second communication circuit 350 may include various components (e.g., the second amplifier 351, the switch 353, the filter 355, and/or the coupler 357) in addition to the second amplifier 351 that perform an operation to amplify a signal received through the second antenna 373 and/or a signal transmitted by the transceiver 320. The signal received or transmitted by the second communication circuit 350 may be a signal within the second frequency band. For example, the second frequency band may be a different band from the first frequency band.

The second amplifier 351 may amplify a signal within the second frequency band transmitted by the transceiver 320. The amplified signal may be transmitted to the second antenna 373 through the switch 353 to connect either a transmission path or a reception path with the filter 355, the filter 355 to pass a signal within a designated frequency band (e.g., the second frequency band), and/or the coupler 357 to monitor the amplified signal.

The power supply circuit 340 may be electrically connected to the first communication circuit 330 and the second communication circuit 330. The power supply circuit 340 may be connected to supply a voltage (e.g., V_{CC1}) required to operate to the first amplifier 331 and the second amplifier 332. According to an embodiment, the power supply circuit 340 may apply voltages to both the first amplifier 331 and the second amplifier 351 to simultaneously implement transmission of signals within the first frequency band and the second frequency band. In this case, the magnitude of the voltages that the power supply circuit 340 applies to the first amplifier 331 and the second amplifier 351 may be identical.

The power supply circuit 340, in certain embodiments, may include an output. Both the first amplifier 331 and the second amplifier 351 may be connected to the output. In certain embodiments, the power supply circuit 340 may include a DC to DC converter. The first amplifier 331 and the second amplifier 351 may be connected to the output of the DC to DC converter.

Amplification gains of the first amplifier 331 and/or the second amplifier 351 may be determined on the basis of a magnitude of a voltage (Vcc1) applied by the first power supply circuit 340 to one of the first amplifier 331 and the second amplifier 351, and a magnitude of a bias voltage applied to the other of first amplifier 331 and the second amplifier 351.

When the first amplifier 331 and/or the second amplifier 351 use bipolar junction transistors (BJTs), the voltage may be applied to a collector terminal of the first amplifier 331 and/or the second amplifier 351. The bias voltage applied to the first amplifier 331 and/or the second amplifier 351 may be applied to the base terminal of the first amplifier 331 and/or the second amplifier 351.

When the first amplifier 331 and/or the second amplifier 351 use field-effect transistors (FETs), a voltage applied by the first power supply circuit 340 may be applied to the drain terminals of the first amplifier 331 and/or the second amplifier 351. The bias voltage may applied to the gate terminals of the first amplifier 331 and/or the second amplifier 351.

The electronic device 101 may include a memory (e.g., the memory 130 of FIG. 1) storing mapping data. In the mapping data, a magnitude of a voltage that the first power supply circuit 340 is capable of applying to the first amplifier 331 and magnitude of a bias voltage of the first amplifier 331 are mapped according to strength of a signal that the first amplifier 331 outputs. Additionally, a magnitude of a voltage that the first power supply circuit 340 is capable of applying to the second amplifier 351 and magnitude of a bias voltage of the second amplifier 351 are mapped according to strength of a signal that the second amplifier 351 outputs.

The mapping data may include a combination of bias voltages and voltages, Vcc, to be applied by the first power supply circuit 340 to the first amplifier 331 and/or the second amplifier 351 to output signals of designated strength. The mapping data may be implemented in a variety of forms, for example, the mapping data may be implemented in the form of a table such as Table 1 below stored in memory.

TABLE 1

| | | | | |
|---|---|---|---|---|
| Amplifier | Output signal strength (dBm) | Input signal strength (dBm) | Magnitude of voltage (Vcc) applied by first power supply circuit 340. | Magnitude of bias voltage |
| First Amplifier 331 | P1 | A11 | V1 | B11 |
| | | A12 | V2 | B12 |
| | | A13 | V3 | B13 |
| Second Amplifier 351 | P2 | A21 | V1 | B21 |
| | | A22 | V2 | B22 |
| | | A23 | V3 | B23 |
| | | A24 | V4 | B24 |
| | | A25 | V5 | B25 |
| | | A26 | V6 | B26 |
| | | A27 | V7 | B27 |
| | | A28 | V8 | B28 |

With reference to Table 1, the mapping data may include a plurality of magnitudes of voltages by which the first amplifier 331 outputs a signal with strength of P1 (e.g., a signal within the first frequency band). For example, the first power supply circuit 340 may apply a voltage with magnitude of V1 to the first amplifier 331, and the communication processor 310 may control a bias voltage application circuit (not illustrated) within the first amplifier 331 to apply a bias voltage with magnitude of B11 to the first amplifier 331 on the basis of the mapping data. In another example, the first power supply circuit 340 may apply a voltage with magnitude V2 to the first amplifier 331, and the communication processor 310 may control the bias voltage application circuit within the first amplifier 331 to apply a bias voltage with magnitude B12 to the first amplifier 330 on the basis of the mapping data. In another example, the first power supply circuit 340 may apply a voltage with magnitude V3 to the first amplifier 331, and the communication processor 310 may control the bias voltage application circuit within the first amplifier 331 to apply a bias voltage with magnitude B13 to the first amplifier 331 on the basis of the mapping data.

With reference to Table 1, the mapping data may include a plurality of magnitudes of voltages by which the second amplifier 351 outputs a signal with strength of P2 (e.g., a signal within the second frequency band). For example, the first power supply circuit 340 may apply a voltage with magnitude of V1 to the second amplifier 351, and the communication processor 310 may control a bias voltage application circuit within the second amplifier 351 to apply a bias voltage with magnitude of B21 to the second amplifier 351 on the basis of the mapping data. In another example, the first power supply circuit 340 may apply a voltage with magnitude of V2 to the second amplifier 351, and the communication processor 310 may control the bias voltage application circuit within the second amplifier 351 to apply a bias voltage with magnitude of B22 to the second amplifier 351 on the basis of the mapping data. In another example, the first power supply circuit 340 may apply a voltage with magnitude of V3 to the second amplifier 351, and the communication processor 310 may control the bias voltage application circuit within the second amplifier 351 to apply a bias voltage with magnitude of B23 to the second amplifier 351 on the basis of the mapping data. In another example, the first power supply circuit 340 may apply a voltage with magnitude of one of V4, V5, V6, V7, or V8 to the second amplifier 351, and the communication processor 310 may control the bias voltage application circuit within the second amplifier 351 to apply a bias voltage to the second amplifier 351 with magnitude corresponding to a voltage applied by the first power supply circuit 340 among B24, B25, B26, B27, or B28 on the basis of the mapping data.

A bias voltage applied to the first amplifier 331 and/or the second amplifier 351 for outputting a designated strength of the signal included in the mapping data and a voltage applied by the first power supply circuit 340 to the first amplifier 331 and/or the second amplifier 351 may be determined in various methods (e.g., tuning, calibration) and may be determined by considering an influence of other components included in the first communication circuit 330 and/or the second communication circuit 350.

The communication processor 310 may receive information from the base station on output strength of a signal to be transmitted to the base station. The information on the output strength of the signal may include, for example, information on strength of a signal within the first frequency band and/or strength of a signal within the second frequency band. The communication processor 310 may identify strength of a signal within the first frequency band and strength of a signal within the second frequency band on the basis of information on output strength of a signal.

The communication processor 310 may identify magnitude of voltages that are capable of being applied to the first amplifier 331 on the basis of a signal strength (e.g., P1) in the first frequency band and the mapping data. With reference to Table 1, the communication processor 310 may identify that magnitude of a voltage that the first power supply circuit 340 is capable of applying to the first amplifier 331 is V1, V2, or V3 in order to output the signal strength P1 of the first frequency band.

The communication processor 310 may identify magnitude of voltages that are capable of being applied to the second amplifier 351 on the basis of a signal strength (e.g., P2) in the first frequency band and the mapping data. With reference to Table 1, the communication processor 310 may identify that magnitude of a voltage that the first power supply circuit 340 is capable of applying to the second amplifier 351 is one of V1, V2, V3, V4, V5, V6, V7, or V8 in order to output the signal strength P2 of the second frequency band.

The communication processor 310 may determine voltage values to be applied to the first amplifier 331 and/or the second amplifier 351 as identical values (e.g., V1, V2 and V3) among magnitudes V 1, V2 and V3 of voltages applicable to the first amplifier 331 and magnitudes V1, V2, V3, V4, V5, V6, V7 and V8 of voltages applicable to the second amplifier 351. For example, the communication processor 310 may determine a voltage value to be applied to the first amplifier 331 and/or the second amplifier 351 as V3, which is an identical value among magnitudes V1, V2 and V3 of voltages applicable to the first amplifier 331 and magnitudes V1, V2, V3, V4, V5, V6, V7 and V8 of voltages applicable to the second amplifier 351.

When there are a plurality of identical values V1, V2 and V3 among magnitudes V1, V2 and V3 of voltages applicable to the first amplifier 331 and magnitudes V1, V2, V3, V4, V5, V6, V7 and V8 of voltages applicable to the second amplifier 351, the communication processor 310 may determine the smallest of the plurality of the magnitude of the voltage (e.g., V3) as a voltage value to be applied to the first amplifier 331 and/or the second amplifier 351.

The communication processor 310 may control the first power circuit 340 to apply the determined voltage value V3 to the first amplifier 331 and/or the second amplifier 351.

The communication processor 310 may determine a bias voltage to be applied to the first amplifier 331 on the basis of the determined voltage value V3 and the mapping data. With reference to Table 1, the communication processor 310 may determine a bias voltage B13 corresponding to the determined voltage value V3 as a bias voltage to be applied to the first amplifier 331, and control the bias voltage application circuit within the first amplifier 331 to apply the determined voltage B13 to the first amplifier 331. The communication processor 310 may determine a bias voltage to be applied to the second amplifier 351 on the basis of the determined voltage value V3 and the mapping data. With reference to Table 1, the communication processor 310 may determine the bias voltage B23 corresponding to the determined voltage value V3 as a bias voltage to be applied to the second amplifier 351, and control the bias voltage application circuit within the second amplifier 351 to apply the determined voltage B23 to the second amplifier 351. The communication processor 310 may determine, on the basis of the mapping data, magnitude of a bias voltage to be applied to the first amplifier 331 and/or magnitude of a bias voltage to be applied to the second amplifier 351 to control the transceiver 320, and apply a voltage with the determined magnitude to the first amplifier 331 and/or the second amplifier 351.

With the mapping data described above, the electronic device 101 according to certain embodiments of the present disclosure may simultaneously apply the identical value of voltage to the first amplifier 331 and the second amplifier 351, and the electronic device 101 may support EN-DC or CA by amplifying and outputting a signal within the first frequency band and a signal within the second frequency band through the single power supply circuit 340.

The communication processor 310 may receive information on strength of a signal to be output within the first frequency band and/or strength of a signal to be output within the second frequency band from the base station. The communication processor 310 may identify that strength of a signal to be output within the first frequency band and/or strength of a signal to be output within the second frequency band has changed on the basis of information received from the base station. Accordingly, the communication processor 310 can change magnitude of a voltage that the first power supply circuit 340 applies to the first amplifier 331 and/or the second amplifier 351 on the basis of the mapping data. The communication processor 310 may change bias voltages of the first amplifier 331 and/or the second amplifier 351 on the basis of the mapping data. In response the power supply circuit 340 changes magnitude of a voltage applied to the first amplifier 331 and/or the second amplifier 351.

The electronic device 101 is illustrated in FIG. 4 as including the first communication circuit 330 and the second communication circuit 350, assuming that the electronic device 101 supports two frequency bands (e.g., the first frequency band and the second frequency band). However, the electronic device 101 may include a plurality of communication circuits according to simultaneous transmission or reception of signals over different frequency bands supported by the communication circuit 330. For example, the communication circuit 330 may include three communication circuits to support three frequency bands. Even in this case, the electronic device 101 according to certain embodiments of the present disclosure may utilize a single power supply circuit (e.g., the first power supply circuit 340) by configuring voltages applied to the amplifiers to be the identical.

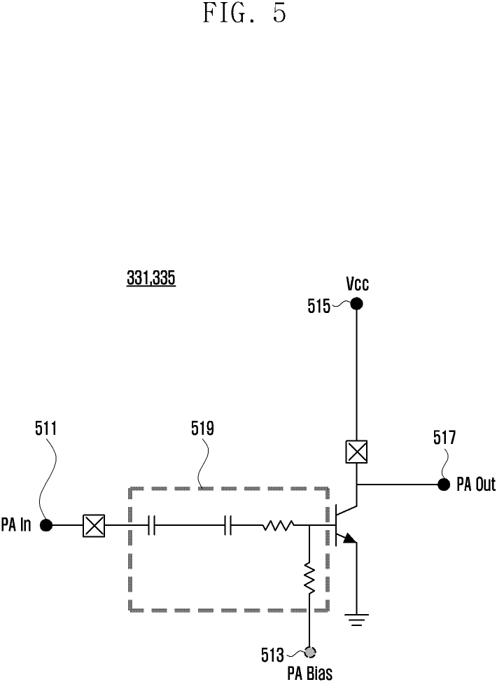

FIG. 5 is a view illustrating an amplifier that can be the first amplifier 331 and/or the second amplifier 351 according to certain embodiments of the present disclosure.

With reference to FIG. 5, the amplifier may include a first port 511 (an input) receiving a signal to be amplified, a second port 513 receiving a bias voltage, a third port 515 receiving a voltage Vcc from a power supply circuit (e.g., the first power supply circuit 340 of FIG. 4), and/or a fourth port 517 (an output) outputting the amplified signal.

The amplifier may be electrically coupled with various elements 519, depending on the designer’s intent. For example, the various elements 519 may include passive elements (resistors, inductors, or capacitors) and/or active elements, and may be utilized to determine a power gain of the first amplifier 331 and the second amplifier 351.

A communication processor (e.g., the communication processor 310 of FIG. 4) may identify strength of a signal to be output within the first frequency band and strength of a signal to be output within the second frequency band. Based on the strength of the signal to output and the mapping data, the communication processor may determine the strength of a voltage to be applied through the second port 513 and strength of a voltage to be applied through the third port 515.

The communication processor 310 may determine strength of a voltage to be applied through the third port 515 and control the first power supply circuit 340 to apply the determined voltage. The communication processor 310 may determine strength of a bias voltage to be applied through the second port 513, and apply the determined voltage to the first amplifier 331 and/or the second amplifier 351. The communication processor 310 may apply a voltage determined by applying a bias voltage directly to the second port 513 to the first amplifier 331 and/or the second amplifier 351 in a path of a control signal connected through the transceiver 320.

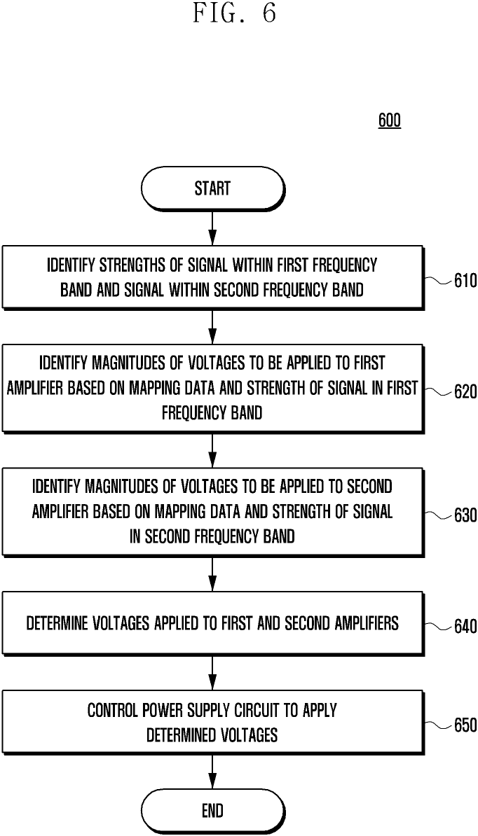

FIG. 6 is a flowchart illustrating a method of operating an electronic device 600 according to certain embodiments of the present disclosure.

At operation 610, an electronic device (e.g., the electronic device 101 of FIG. 4) may identify strength of a signal to be output within the first frequency band and strength of a signal to be output within the second frequency band.

The electronic device 101 may receive, from the base station (not illustrated), information on an output strength of a signal to be transmitted to the base station. The information on output strength of a signal may include information on strength of a signal within the first frequency band and/or strength of a signal within the second frequency band. The electronic device 101 may determine strength of a signal to be output within the first frequency band and the second frequency band based on the information on output strength of a signal.

At operation 620, the electronic device 101 may determine magnitude of a voltage to be applied to the first amplifier (e.g., the first amplifier 331 of FIG. 4) based on the mapping data and the determined strength of the signal to be output within the first frequency band.

The mapping data may include a combination of a bias voltage to be applied to the first amplifier 331 and/or the second amplifier 351 and a voltage Vcc to be applied by the first power supply circuit 340 to the first amplifier 331 and/or the second amplifier 351 in order for the first amplifier 331 and/or the second amplifier 351 to output a signal of designated strength. The voltage Vcc that is applied by the power supply circuit 340 may be referred to as the Voltage Common Collector and may be applied to a collector of a transistor of the amplifier.

For example, with reference to Table 1, the electronic device 101 may identify that magnitude of a voltage that the power supply circuit 340 is capable of applying to the first amplifier 331 is V1, V2, or V3 to output strength P1 of a signal within the first frequency band.

At operation 630, the electronic device 101 may identify magnitude of a voltage to be applied to the second amplifier (e.g., the second amplifier 351 of FIG. 4) on the basis of the mapping data and strength of a signal within the second frequency band.

For example, with reference to Table 1, the electronic device 101 can identify that magnitude of a voltage that the first power supply circuit 340 is capable of applying to the second amplifier 351 is one of V1, V2, V3, V4, V5, V6, V7, or V8 to output strength P2 of a signal within the second frequency band.

In operation 640, the electronic device 101 may determine a voltage applied to the first amplifier 331 and the second amplifier 351.

The electronic device 101 may determine voltage values to be applied to the first amplifier 331 and/or the second amplifier 351 as identical values (e.g., V1, V2 and V3) among magnitudes V1, V2 and V3 of voltages applicable to the first amplifier 331 and magnitudes V1, V2, V3, V4, V5, V6, V7 and V8 of voltages applicable to the second amplifier 351. For example, the electronic device 101 may determine a voltage value to be applied to the first amplifier 331 and/or the second amplifier 351 as V3, which is an identical value among magnitudes V1, V2 and V3 of voltages applicable to the first amplifier 331 and magnitudes V1, V2, V3, V4, V5, V6, V7 and V8 of voltages applicable to the second amplifier 351.

When there are a plurality of identical values V1, V2 and V3 among magnitudes V1, V2 and V3 of voltages applicable to the first amplifier 331 and magnitudes V1, V2, V3, V4, V5, V6, V7 and V8 of voltages applicable to the second amplifier 351, the electronic device 101 may determine the smallest of the plurality of the magnitude of the voltage (e.g., V3) as a voltage value to be applied to the first amplifier 331 and/or the second amplifier 351.

At operation 650, the electronic device 101 may control a power supply circuit (e.g., the first power supply circuit 340 of FIG. 4) to apply the determined voltage to the first amplifier 331 and the second amplifier 351.

The electronic device 101 may determine a bias voltage to be applied to the first amplifier 331 on the basis of the determined voltage value V3 and the mapping data. For example, with reference to Table 1, the electronic device 101 may determine the bias voltage B13 corresponding to the determined voltage value V3 as a bias voltage to be applied to the first amplifier 331, and control the bias voltage application circuit of the first amplifier 331 to apply the determined voltage B13 to the first amplifier 331. The electronic device 101 may determine a bias voltage to be applied to the second amplifier 351 on the basis of the determined voltage value V3 and the mapping data. As another example, with reference to Table 1, the electronic device 101 may determine the bias voltage B23 corresponding to the determined voltage value V3 as a bias voltage to be applied to the second amplifier 351, and control the bias voltage application circuit of the second amplifier 351 to apply the determined voltage B23 to the second amplifier 351.

With the mapping data described above, the electronic device 101 according to certain embodiments of the present disclosure may simultaneously apply voltages to the first amplifier 331 and the second amplifier 351, and the electronic device 101 may support EN-DC or CA by amplifying and outputting a signal within the first frequency band and a signal within the second frequency band through the single first power supply circuit 340.

An electronic device (e.g., the electronic device 101 of FIG. 1) according to certain embodiments of the present disclosure may include: a communication processor (e.g., the communication processor 310 of FIG. 4); a memory (e.g., the memory 130 of FIG. 1) storing mapping data mapping first magnitudes of voltages according to strength of a signal within a first frequency band, and second magnitudes of voltages according to strength of a signal within a second frequency band; a first amplifier 331 to amplify a signal within the first frequency band; a second amplifier 351 to amplify a signal within the second frequency band; and the power supply circuit 340 to apply a voltage to the first amplifier 331 and/or the second amplifier 351, in which when operating in a mode of transmitting a signal within the first frequency band and a signal within the second frequency band, the communication processor 310 may be configured to: identify strength of a signal within the first frequency band and strength of a signal within the second frequency band; identify first magnitudes of voltages applicable to the first amplifier 331 based on the strength of the signal within the first frequency band and the mapping data; identify second magnitudes of voltages applicable to the second amplifier 351 based on the strength of the signal within the second frequency band and the mapping data; and when there are identical magnitudes of voltages among the first magnitudes of voltages and the second magnitudes of voltages control the power supply circuit 340 to apply the identical magnitudes of voltages to the first amplifier 331 and/or the second amplifier 351.

When the identical magnitudes of voltages include a plurality of identical magnitudes of voltages, the communication processor is configured to control the power supply circuit to apply the smallest value of the plurality of identical magnitudes of voltages to the first amplifier 331 and the second amplifier 351.

In the electronic device 101 according to certain embodiments of the present disclosure, the mapping data may be configured that first magnitudes of bias voltages are mapped according to strength of signal within the first frequency band, and second magnitudes of bias voltages are mapped according to strength of a signal within the second frequency band.

In the electronic device 101 according to certain embodiments of the present disclosure, the communication processor 310 may be configured to determine a voltage of the first magnitudes of the bias voltages and a voltage of the second magnitudes of the bias voltages based on the identical magnitudes of voltages and the mapping data.

In the electronic device 101 according to certain embodiments of the present disclosure, the communication processor 310 may be configured to apply the voltage of the first magnitudes of the bias voltage to the first amplifier 331 and to apply the voltage of the second magnitudes of bias voltages to the second amplifier 351.

In the electronic device 101 according to certain embodiments of the present disclosure, the communication processor 310 may be configured to change voltages to be applied to the first amplifier 331 and the second amplifier 351 based on the mapping data in response to a change in strength of the signal within the first frequency band and the signal within the second frequency band.

The electronic device 101 according to certain embodiments of the present disclosure may include: the communication processor 310; a first amplifier 331 configured to amplify a signal within the first frequency band; the second amplifier 351 configured to amplify a signal within the second frequency band; and a power supply circuit 340 configured to apply a voltage to the first amplifier 331 and/or the second amplifier 351, in which when operating in a mode of outputting a signal within the first frequency band and a signal within the second frequency band, the communication processor 310 may be configured to: identify strength of a signal within the first frequency band and strength of a signal within the second frequency band; and control the power supply circuit 340 to apply identical voltages to the first amplifier 331 and/or the second amplifier 351 based on the strength of the signal within the first frequency band and the strength of the signal within the second frequency band.

The electronic device 101 according to certain embodiments of the present disclosure further includes a memory 130, and the memory 130 stores mapping data mapping first magnitudes of the voltages according to strength of signal within the first frequency band and second magnitudes of the voltages according to strength of signal within the second frequency band.

In the electronic device 101 according to certain embodiments of the present disclosure, the communication processor 310 may be configured to control the power supply circuit to apply a voltage to the first amplifier and the second amplifier, wherein the voltage corresponds to the identified strength of signal within the first frequency band and the identified strength of signal within the second frequency band in the mapping data

In the electronic device 101 according to certain embodiments of the present disclosure, the mapping data may be configured that first magnitudes of bias voltages are mapped according to strength of signal within the first frequency band, and second magnitudes of bias voltages are mapped according to strength of a signal within the second frequency band.

In the electronic device 101 according to certain embodiments of the present disclosure, the communication processor 310 may be configured to determine one of the first magnitudes a bias voltages to be applied to the first amplifier 331 and one of the second magnitudes of a bias voltages to be applied to the second amplifier 351 in response to the voltage applied to the first amplifier and the second amplifier based on the mapping data.

In the electronic device 101 according to certain embodiments of the present disclosure, the communication processor 310 may be configured to apply a voltage to the first amplifier 331 having magnitude of a bias voltage to be applied to the first amplifier 331 and to apply a voltage to the second amplifier 351 having magnitude of a bias voltage to be applied to the second amplifier 351.

In the electronic device 101 according to certain embodiments of the present disclosure, in response to a plurality of voltages with the identical value among the voltages to be applied to the first amplifier 331 and the voltages to be applied to the second amplifier 351 by the power supply circuit 340, the communication processor 310 may be configured to determine voltages corresponding to the smallest value as voltages to be applied to the first amplifier 331 and the second amplifier 351.

In the electronic device 101 according to certain embodiments of the present disclosure, in response to a change in strength of a signal within the first frequency band and a change in strength of a signal within the second frequency band, the communication processor 310 may be configured to change voltages to be applied to the first amplifier 331 and the second amplifier 351 on the basis of the mapping data.

A method of operating the electronic device 101 according to certain embodiments of the present disclosure may include: when operating in a mode of transmitting a signal within the first frequency band and a signal within the second frequency band, identifying strength of a signal within the first frequency band and strength of a signal within the second frequency band; identifying first magnitudes of voltages based on mapping data in a memory, wherein the mapping data maps first magnitudes of the voltages according to strength of signal within the first frequency band and second magnitudes of the voltages according to strength of signal within the second frequency band, and the identified strength of the signal within the first frequency band; identifying the second magnitudes of the voltages based on the identified strength of the signal within the second frequency band and the mapping data; and when there are identical magnitude of voltages among the first magnitudes of voltages applicable and the second magnitudes of voltages,, controlling a power supply circuit to apply the identical magnitude of voltages to a first amplifier and/or a second amplifier.

.

In certain embodiments, the method further comprises: when the identical magnitudes of voltages include a plurality of identical magnitudes of voltages, applying a smallest value of the plurality of identical magnitudes of voltages to the first amplifier and the second amplifier.

In certain embodiments, the mapping data is configured that first magnitudes of bias voltages are mapped according to strength of signal within the first frequency band, and second magnitudes of bias voltages are mapped according to strength of signal within the second frequency band.

In certain embodiments, the method further comprises determining a voltage of the first magnitudes of the bias voltages and a voltage of the second magnitudes of the bias voltages based on the identical magnitudes of voltages and the mapping data.

In certain embodiments, the method further comprises applying the voltage of the first magnitudes of the bias voltages to the first amplifier; and applying the voltage of the second magnitudes of bias voltages to the second amplifier.

In certain embodiments, the method further comprises changing voltages to be applied to the first amplifier and the second amplifier based on the mapping data in response to a change in the strength of the signal within the first frequency band and the signal within the second frequency band.

The method of operating the electronic device 101 according to certain embodiments of the present disclosure may further include: in response to a plurality of voltages with the identical value among the magnitudes of the voltages applicable to the first amplifier 331 and the magnitudes of the voltages applicable to the second amplifier 351, determining a voltage corresponding to the smallest value of the plurality of voltages as a voltage to be applied to the first amplifier 331 and the second amplifier 351.

In the method of operating the electronic device 101 according to certain embodiments of the present disclosure, the mapping data may be configured magnitudes of bias voltages to be applied to the first amplifier 331 are mapped according to the strength of the signal within the first frequency band, and magnitudes of bias voltages to be applied to the second amplifier 351 are mapped according to the strength of the signal within the second frequency band.

The method of operating the electronic device 101 according to certain embodiments of the present disclosure may further include: determining magnitude of a bias voltage to be applied to the first amplifier 331 and magnitude of a bias voltage to be applied to the second amplifier 351 on the basis of the determined voltage and the mapping data.

The method of operating the electronic device 101 according to certain embodiments of the present disclosure may further include: applying a voltage having the magnitude of the bias voltage to be applied to the first amplifier 331; and applying a voltage having the magnitude of the bias voltage to be applied to the second amplifier 351.

The method of operating the electronic device 101 according to certain embodiments of the present disclosure may further include: in response to a change in the strength of the signal within the first frequency band and/or the strength of the signal within the second frequency band, changing voltages to be applied to the first amplifier 331 and the second amplifier 351 on the basis of the mapping data.

The electronic device according to certain embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that certain embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Certain embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to certain embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer’s server, a server of the application store, or a relay server.

According to certain embodiments, each component (e.g., a module or a program) of the above-described components may include a single entity or multiple entities. According to certain embodiments, one or more of the above-described components may be omitted, or one or more other components may be added. Alternatively or additionally, a plurality of components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a communication processor;
a memory storing mapping data mapping first magnitudes of voltages according to strength of a signal within a first frequency band, and second magnitudes of voltages according to strength of a signal within a second frequency band; and
a first amplifier configured to amplify a signal within the first frequency band;
a second amplifier configured to amplify a signal within the second frequency band; and
a power supply circuit configured to apply a voltage to the first amplifier and/or the second amplifier, and
wherein when operating in a mode of transmitting a signal within the first frequency band and a signal within the second frequency band, the communication processor is configured to:
identify strength of a signal within the first frequency band and strength of a signal within the second frequency band;
identify first magnitudes of voltages applicable to the first amplifier based on the strength of the signal within the first frequency band and the mapping data;
identify second magnitudes of voltages applicable to the second amplifier based on the strength of the signal within the second frequency band and the mapping data; and
when there are identical magnitudes of voltages among the first magnitudes of voltages and the second magnitudes of voltages,
control the power supply circuit to apply the identical magnitudes of voltages to the first amplifier and/or the second amplifier.

2. The electronic device of claim 1, wherein when the identical magnitudes of voltages include a plurality of identical magnitudes of voltages, the communication processor is configured to control the power supply circuit to apply a smallest value of the plurality of identical magnitudes of voltages to the first amplifier and the second amplifier.

3. The electronic device of claim 1, wherein the mapping data is configured that first magnitudes of bias voltages are mapped according to strength of signal within the first frequency band, and second magnitudes of bias voltages are mapped according to strength of signal within the second frequency band.

4. The electronic device of claim 3, wherein the communication processor is configured to determine a voltage of the first magnitudes of the bias voltages and a voltage of the second magnitudes of the bias voltages based on the identical magnitudes of voltages and the mapping data.

5. The electronic device of claim 4, wherein the communication processor is configured to apply the voltage of the first magnitudes of the bias voltages to the first amplifier and to apply the voltage of the second magnitudes of bias voltages to the second amplifier.

6. The electronic device of claim 1, wherein the communication processor is configured to change voltages to be applied to the first amplifier and the second amplifier based on the mapping data in response to a change in the strength of the signal within the first frequency band of and the signal within the second frequency band.

7. An electronic device comprising:
a communication processor; and
a first amplifier configured to amplify a signal within a first frequency band;
a second amplifier configured to amplify a signal within a second frequency band; and
a power supply circuit configured to apply voltages to the first amplifier and the second amplifier,
wherein when operating in a mode of outputting a signal within the first frequency band and a signal within the second frequency band, the communication processor is configured to:
identify strength of a signal within the first frequency band and strength of a signal within the second frequency band; and
control the power supply circuit to apply identical voltages to the first amplifier and the second amplifier based on the strength of the signal within the first frequency band and the strength of the signal within the second frequency band.

8. The electronic device of claim 7, further comprising:
a memory,
wherein the memory stores mapping data mapping first magnitudes of the voltages according to strength of signal within the first frequency band and second magnitudes of the voltages according to strength of signal within the second frequency band.

9. The electronic device of claim 8, wherein the communication processor is configured to control the power supply circuit to apply a voltage to the first amplifier and the second amplifier, wherein the voltage corresponds to the identified strength of signal within the first frequency band and the identified strength of signal within the second frequency band in the mapping data.

10. The electronic device of claim 9, wherein the mapping data is configured that first magnitudes of bias voltages are mapped according to strength of signal within the first frequency band, and second magnitudes of bias voltages are mapped according to the strength of signal within the second frequency band.

11. The electronic device of claim 10, wherein the communication processor is configured to determine one of the first magnitudes of bias voltages to be applied to the first amplifier and one of the second magnitudes of a bias voltages to be applied to the second amplifier in response to the voltage applied to the first amplifier and the second amplifier based on the mapping data.

12. The electronic device of claim 11, wherein the communication processor is configured to apply the one of the first magnitudes of bias voltages to the first amplifier and to apply the one of the second magnitudes of voltages to the second amplifier.

13. The electronic device of claim 9, wherein when there are a plurality of voltages with identical values corresponding to the identified strength of the signal in the first frequency band and the identified strength of the signal in the second frequency band, the communication processor a smallest one of the plurality of voltages to the first amplifier and the second amplifier.

14. The electronic device of claim 8, wherein the communication processor is configured to change voltages to be applied to the first amplifier and the second amplifier on based on the mapping data in response to a change in the strength of a signal within the first frequency band and/or a change in the strength of a signal within the second frequency band.

15. A method of operating an electronic device, the method comprising:
identifying strength of a signal within a first frequency band and strength of a signal within a second frequency band when operating in a mode of transmitting a signal within the first frequency band and a signal within the second frequency band;
identifying first magnitudes of voltages based on mapping data in a memory, wherein the mapping data maps first magnitudes of the voltages according to strength of signal within the first frequency band and second magnitudes of the voltages according to strength of signal within the second frequency band, and the identified strength of the signal within the first frequency band;
identifying the second magnitudes of the voltages based on the identified strength of the signal within the second frequency band and the mapping data;
when there are identical magnitude of voltages among the first magnitudes of voltages applicable and the second magnitudes of voltages,
controlling a power supply circuit to apply the identical magnitude of voltages to a first amplifier and/or a second amplifier.

16. The method of claim 15, further comprising:
when the identical magnitudes of voltages include a plurality of identical magnitudes of voltages, applying a smallest value of the plurality of identical magnitudes of voltages to the first amplifier and the second amplifier.

17. The method of claim 15, wherein the mapping data is configured that first magnitudes of bias voltages are mapped according to strength of signal within the first frequency band, and second magnitudes of bias voltages are mapped according to strength of signal within the second frequency band.

18. The method of claim 17, further comprising:
determining a voltage of the first magnitudes of the bias voltages and a voltage of the second magnitudes of the bias voltages based on the identical magnitudes of voltages and the mapping data.

19. The method of claim 18, further comprising:
applying the voltage of the first magnitudes of the bias voltages to the first amplifier; and
applying the voltage of the second magnitudes of bias voltages to the second amplifier.

20. The method of claim 15, further comprising:
changing voltages to be applied to the first amplifier and the second amplifier based on the mapping data in response to a change in the strength of the signal within the first frequency band and the signal within the second frequency band.
